(19) United States
(12) Patent Application Publication
(10) Pub. No.: US 2007/0295762 A1
(43) Pub. Date: Dec. 27, 2007

(54) EASY-OPEN DISPENSING CAP

(75) Inventor: Eric Zeitlin, Baldwin, NY (US)

Correspondence Address: TROUTMAN SANDERS LLP, 600 PEACHTREE STREET , NE, ATLANTA, GA, 30308, US

(73) Assignee: Lifetime Brands, Inc., Garden City, NY (US)

(21) Appl. No.: 11/739,287

(22) Filed: Apr. 24, 2007

Related U.S. Application Data
(60) Provisional application No. 60/794,877, filed on Apr. 25, 2006.

(51) Int. Cl. B67D 3/00; B65D 47/00; A47G 19/24

(52) U.S. Cl. 222/480; 222/565; 222/561

(57) ABSTRACT

A dispensing device for dispensing the contents of a container. The dispensing device includes a dispensing gate having an open position and a closed position, a closing system for moving the dispensing gate from the opened position to the closed position, and a restraint system to limit the movement of the dispensing gate only between the open position and the closed position. The dispensing gate defines a plurality of apertures that substantially match the apertures defined by a cover, such that, in the open position, the plurality of apertures of the dispensing gate is aligned with the apertures of the cover, thereby allowing contents to be dispensed from the container. The closing system can be engaged when the dispensing gate is in the open position, thereby causing a bias to move the dispensing gate from the open position to the closed position.

### CROSS REFERENCE TO RELATED APPLICATION

This application claims priority of U.S. Provisional Patent Application No. 60/794,877 filed 25 Apr. 2006, the entire contents of which is hereby incorporated by reference.

### TECHNICAL FIELD

The present invention relates generally to a dispensing device for a container, and in particular to an easy-open dispensing cap for a container that can be manipulated with one hand.

### BACKGROUND OF THE INVENTION

Dispensing containers are used in a variety of industries, for many different purposes. Generally, dispensing containers contain specific contents, such as liquids or particulates, which can be dispensed by an individual when desired. To prevent the contents of the container from being dispensed accidentally, many dispensing containers include a cap or lid that remains on the container during periods of nonuse.

In the food industry, dispensing containers that contain solid foods, such as herbs or spices, in granular or powder-like form, are commonly used. Dispensing containers are often bountiful in the kitchen, containing such materials as salt, pepper, basil, cinnamon, dill, mustard powder, garlic salt or powder, ginger, thyme, rosemary, nutmeg, oregano, paprika, parsley, saffron, and turmeric, just to name a few. Such materials are key ingredients in a variety of recipes for various foods.

In the culinary arts, a busy kitchen can be the focal point of creation, disarray, and demanding conditions. Amateur and professional chefs are often required to multitask during the cooking and/or creation process. For example, a cook may be stirring a substance with one hand, while adding additional ingredients with the other hand. Additionally, only one clean hand may be available for handling dispensing containers and utensils, because the other hand has been handling or preparing the food ingredients.

Typical dispensing containers, however, require the use of two hands for both removing the cap or lid of the dispensing container, and putting the cap or lid back on the dispensing container after use. Cooks are often left with the dilemma of either taking the chance of opening the dispensing container with dirty hands, or halting the food preparation process to wash or wipe their hands before handling the dispensing container. When a cook opens the dispensing container with dirty hands, the process often involves an awkward handling of the dispensing container in an attempt to not get the dispensing container dirty.

What is needed is an easy-open dispensing cap for a container that can be opened and closed easily with the use of only one hand, while adequately enabling the dispensing of contents in the open position, and securing the contents within the container in the closed position. It is to such a device that the present invention is primarily directed.

### BRIEF SUMMARY OF THE INVENTION

Briefly described, in preferred form, the present invention is a dispensing device for dispensing the contents of a container. The dispensing device includes an easy-open dispensing cap having an open position and a closed position, a closing system for moving the cap from the open position to the closed position, and a restraint system to limit the movement of the easy-open dispensing cap only between the open position and the closed position. In the open position, the contents can be dispensed from the inside to the outside of the container, but, in the closed position, the contents cannot be dispensed to the outside of the container.

The closing system can comprise a bias that influences the cap to the closed position and a triggering or release mechanism adapted to activate the bias, when the cap is in the open position. Accordingly, the triggering or release mechanism activates the bias to move a dispensing gate of the cap from the open position to the closed position so that no further contents of the container can be dispensed, until the dispensing gate is moved back to the open position.

The dispensing device can further comprise a guide system adapted to provide guided travel of the dispensing gate, thereby ensuring that the restraint system is properly aligned to adequately maintain the dispensing gate in the open and closed positions. In a preferred embodiment, the guide system prevents rotational movement, limiting the dispensing gate to only a forward and backward (horizontal) line of travel.

Although the present invention described above refers to systems, the physical elements of the present invention include a housing adapted to engage the container, a dispensing gate receivable within the housing (having an open and closed position), a spring in communication with the dispensing gate, a cover adapted to engage the top of the housing to partially encapsulate the dispensing gate within the housing, a restraint extension adapted to maintain the dispensing gate in the closed position, and a triggering or release button adapted to engage the spring to move the dispensing gate from the open position to the closed position. The cover and dispensing gate are formed to define one or more corresponding apertures for dispensing the contents of the container, such that contents within the container can be dispensed when the aperture(s) of the cover is aligned with the aperture(s) of the dispensing gate.

The present invention further comprises a groove defined by guide walls within the housing, wherein the defined groove provides a pathway for the dispensing gate to move between the open and closed positions. Further, the guide walls prevent the dispensing gate from undesirable moving in a rotational direction.

The housing of the dispensing device can also include a catch adapted to temporarily engage and maintain the dispensing gate in the open position. The catch adequately maintains the dispensing gate in the open position, until the triggering or release button is engaged, thereby activating the spring to move the dispensing gate from the open position to the closed position where the restraint extension engages the dispensing gate.

In operation, beginning with the dispensing gate in the closed position, the restraint extension engages the dispensing gate, thereby maintaining the dispensing gate in the closed position. In the closed position, the apertures of the dispensing gate are not aligned with the apertures of the cover and, therefore, the contents of the container cannot be dispensed to the outside of the container. The spring is relaxed or non-energized, as the dispensing gate is already biased to the closed position. In the closed position, a portion of the dispensing gate extends outside the housing, such that an individual can access a proximate end of the dispensing gate.

If the individual pushes the proximate end of the dispensing gate inwardly towards the housing, the dispensing gate slides (generally horizontally) forward, whereby the dispensing gate disengages with the restraint extension of the housing. After the dispensing gate has moved forward a predetermined distance, the dispensing gate engages the catch of the housing, thereby maintaining the dispensing gate in the open position. In the open position, the apertures of the dispensing gate are aligned with the apertures of the cover, thereby allowing contents of the container to be dispensed. During the dispensing gate's movement towards the open position, the spring compresses and enters an energized state, wherein the spring attempts to bias the dispensing gate towards the closed position. The catch temporarily prevents the spring from moving the dispensing gate back towards the closed position.

After dispensing, the individual engages the triggering or release button by, for example, pressing the button inwardly towards the housing or upwardly. The triggering or release button causes the catch to disengage with the dispensing gate, thereby allowing the spring to move the dispensing gate back towards the closed position, whereupon the restraint extension engages the dispensing gate and maintains the dispensing gate in the closed position.

A principle object of the present invention is to provide a dispensing device that can be moved between an open and closed position with only one hand activation.

Another object of the present invention is to provide a dispensing device that allows the contents of a container to be dispensed outside the container when the dispensing device is in the open position, but not the closed position.

Still another object of the present invention is to provide a dispensing device that can be moved from the closed position to the open position by sliding a dispensing gate, preferably, by using only one hand.

It is another object of the present invention to provide a dispensing device that can be moved from the open position to the closed position by activating a triggering or release button, preferably, by using only one hand.

Still another object of the present invention is to provide a cover and dispensing gate defining one or more apertures adapted to allow the contents of the container to be dispensed when the dispensing gate is in the open position, but not the closed position.

Yet another object of the present invention is to provide a bias adapted to move the dispensing gate from the open position to the closed position.

Another object of the present invention is to provide a restraint system adapted to maintain the dispensing gate in the open or closed position.

Still another object of the present invention is to provide a guide system adapted to prevent rotational movement of the dispensing gate and, thereby, maintain a predetermined alignment of the dispensing gate.

It is another object of the invention is to provide a housing to contain the dispensing gate, the bias, the restraint system, and the guide system.

These and other objects, features and advantages of the present invention will become more apparent upon reading the following specification in conjunction with the accompanying drawings.

### BRIEF DESCRIPTION OF THE FIGURES

FIG. 1 illustrates a perspective view of an easy-open dispensing cap for a container in accordance with preferred embodiments of the present invention.

FIGS. 2A-2C, collectively known as FIG. 2, illustrate perspective views of a housing in accordance with preferred embodiments of the present invention.

FIGS. 3A-3B, collectively known as FIG. 3, illustrate perspective views of a dispensing gate in accordance with preferred embodiments of the present invention.

FIGS. 4A-4C, collectively known as FIG. 4, illustrate perspective views of a cover in accordance with preferred embodiments of the present invention.

FIGS. 5A-5B, collectively known as FIG. 5, illustrate perspective views of a dispensing cap in open and closed positions in accordance with preferred embodiments of the present invention.

FIGS. 6A-6I, collectively known as FIG. 6, illustrate perspective views of a dispensing cap with a triggering or release button and a catch in accordance with an alternative embodiment of the present invention.

FIGS. 7A-7D, collectively known as FIG. 7, illustrate perspective views of a dispensing gate defining a predetermined arrangement of apertures in accordance with preferred embodiments of the present invention.

FIGS. 8A-8E, collectively known as FIG. 8, illustrate perspective views of a cover defining a predetermined arrangement of apertures in accordance with preferred embodiments of the present invention.

### DETAILED DESCRIPTION OF THE PREFERRED EMBODIMENTS

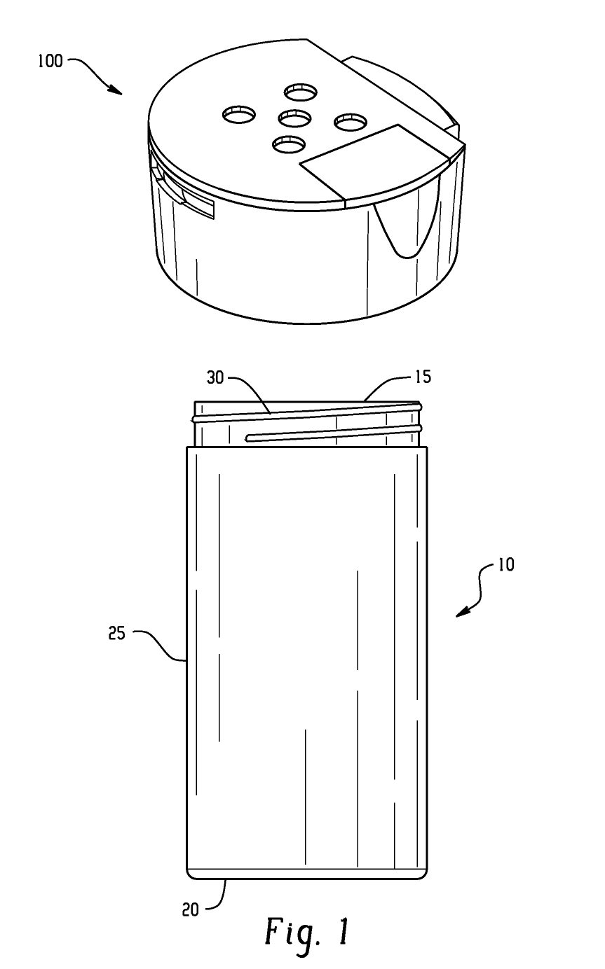

Referring now in detail to the drawing figures, wherein like reference numerals represent like parts throughout the several views, a dispensing device 100 of FIG. 1 utilizes a container 10, typically a cylindrical glass spice container. The dispensing device 100 is designed for allowing contents within the container 10, such as herbs or spices, to be dispensed from the inside of the container 10 to the outside of the container 10 when the dispensing device 100 is in an open position, but prevents contents within the container 10 from being dispensed to the outside of the container 10 when the dispensing device 100 is in a closed position. The dispensing device 100 can be configured for containers 10 of varying sizes and shapes. Generally, the dispensing device 100 is configured for a spice container 10 having an upper open end 15, a bottom 20, and a peripheral wall 25 extending upwardly from the bottom 20 to the upper open end 15. The container 10 can further comprise a helical thread 30 adapted to temporarily engage the dispensing device 100 during use.

As shown in FIGS. 1-5, the dispensing device 100 comprises an easy-open dispensing cap having an open and closed position, a closing system 500, and a restraint system 400. The closing system 500 comprises a triggering or release mechanism 340, 343 and a bias 355 and is adapted to move the dispensing device 100 from the open position to the closed position. The restraint system 400 maintains the dispensing device 100 in the closed position. When activated, the triggering or release mechanism 340, 343 permits the closing system 500 to move the dispensing device 100 from the open position to the closed position.

The triggering or release mechanism 340, 343 of the closing system 500 comprises the interplay between a portion of the dispensing device 100, the bias 355, and the restraint system 400. Generally, the triggering or release mechanism 340, 343 is activated by applying an inwardly and/or upwardly triggering force to the triggering or release mechanism 340, 343. As the triggering or release mechanism 340, 343 is moved slightly inward (or upward), the restraint system 400 temporarily disengages so that the bias 355 can move the dispensing device 100 from the open position to the closed position. Then, the restraint system 400 reengages to maintain the dispensing device 100 in the closed position.

The dispensing device 100 can further comprise a guide system 600, such that the guide system 600 is adapted to guide the dispensing device 100 (or a portion thereof) between the closed position and the open position. Typically, the guide system 600 prevents rotational movement of the dispensing device 100 when moving between the open position and the closed position, or when the dispensing device 100 is restrained by the restraint system 400.

In a preferred embodiment of the present invention, portions of the dispensing device 100 are formed to define one or more dispensing apertures 325, 380. Typically, the dispensing aperture 325 of a first portion of the dispensing device 100 is in communication with the inside of the container 10, but not the outside of the container 10, when the dispensing device 100 is in the closed position. When in the closed position, the dispensing aperture 325 of the first portion of the dispensing device 100 is not aligned with the dispensing aperture 380 of a second portion of the dispensing device 100. Accordingly, the contents of the container 10 cannot be dispensed outside the container 10 when the dispensing device 100 is in the closed position.

The dispensing aperture 325 of a first portion of the dispensing device 100 is aligned with the dispensing aperture 380 of the second portion of the dispensing device 100, when the dispensing device 100 is in the open position. Accordingly, when in the open position, the dispensing aperture 325 of the first portion of the dispensing device 100 is in communication with the inside and outside of the container 10 when the dispensing device 100 is in the open position. When in the open position, the contents of the container 10 can be dispensed from the inside of the container 10 to the outside of the container 10.

More specifically, the dispensing device 100 comprises a housing 200, a dispensing gate 305, a cover 360, a restraint system 400, and a closing system 500. The container 10 interfaces with the housing 200 of the dispensing device 100. The housing 200 has a lower open end 210 adapted to engage the upper open end 15 of the container 10. The closing system 500 is containable within the housing 200, such that the closing system 500 is positioned generally horizontal within the housing 200. One skilled in the art will recognize, however, that the closing system 500 can be positioned in various configurations within the scope of the present invention and, therefore, is not limited to the horizontal configuration described above.

A dispensing system 300 includes the interplay between the dispensing gate 305 and the cover 360 which allows the contents within the container 10 to be dispensed to the outside of the container 10. When properly aligned, the dispensing gate 305 and the cover 360 can provide a passage or channel between the inside of the container 10 and the outside of the container 10, so that the contents of the container 10 can be easily removed or dispensed from within the container 10. Further, the dispensing gate 305 can be partially extended outside of the housing 200 by the closing system 500. The closing system 500 generally biases the dispensing gate 305 towards the outside of the housing 200, while the restraint system 400 is adapted to maintain the dispensing gate 305 in the closed position, extending partially outside the housing 200.

As mentioned above, the dispensing device 100 can further comprise a guide system 600. The guide system 600 is containable within (or defined by) the housing 200 and, more particularly, is adapted to guide the dispensing gate 305 between the closed position and the open position. The guide system 600 generally provides a linear pathway (or groove) for the dispensing gate 305 to move within, as the dispensing gate 305 moves between the open and closed positions. Further, the guide system 600 prevents rotational movement of the dispensing gate 305 during use, thereby ensuring that the dispensing gate 305 moves smoothly between the open and closed positions.

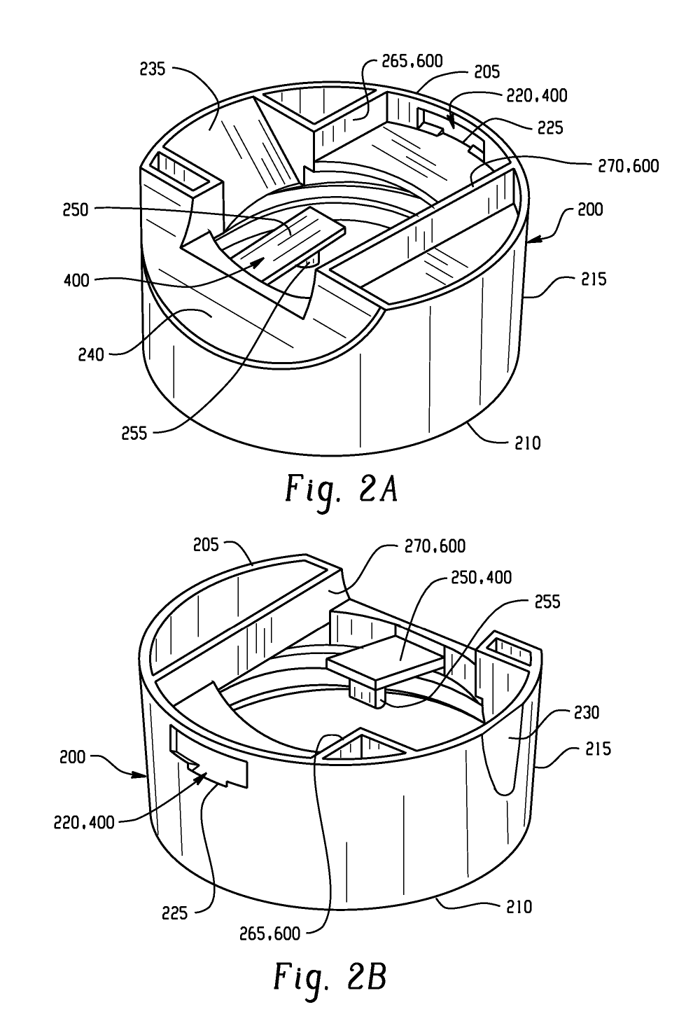

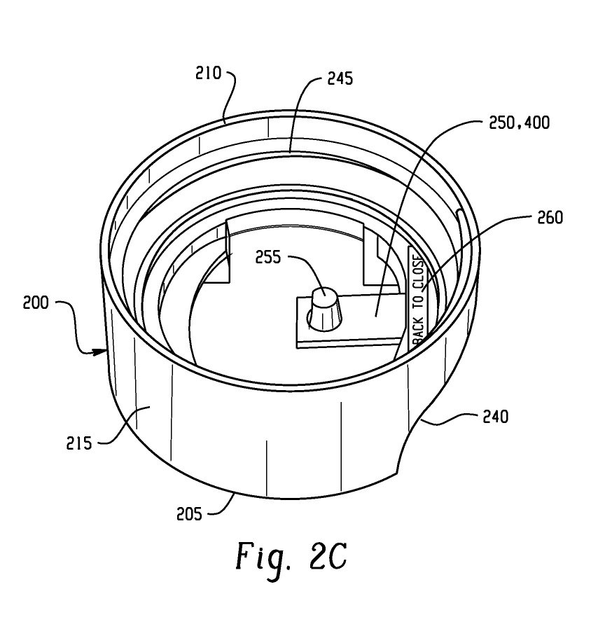

The housing 200, as illustrated in FIGS. 2A-2C, comprises a lower open end 210, an upper open end 205, and a peripheral side wall 215 having an outer side and an inner side. As described above, the lower open end 210 of the housing 200 is adapted to engage the upper open end 15 of the container 10. One skilled in the art will recognize that the lower open end 210 of the housing 200 can be attached to the upper open end 15 of the container 10 in a variety of ways including, but not limited to, an adhesive such as paste, glue, tape, or bond; a bolt, screw, peg, or pin; a clamp; a fastener; a clip; a rivet; a hinge; a coupling; a weld; or other appropriate attachment.

Preferably, a helical thread 245 is in communication with the inner side of the peripheral side wall 215 of the housing 200, such that the helical thread 245 is positioned near the lower open end 210 of the housing 200. Likewise, the outer side of the upper open end 15 of the container 10 comprises a similar helical thread 30, so that the housing 200 can easily be screwed on and off of the container 10.

The upper open end 205 of the housing 200 is adapted to receive the cover 360, as described more fully below. The peripheral side wall 215 of the housing 200 is formed to define a slanted cutaway 240 at a proximal side of the housing 200. Further the peripheral side wall 215 of the housing 200 is formed to define an aperture 220 at a distal side of the housing 200, opposite the proximal side. The aperture 220 is adapted to receive the triggering or release mechanism 340, 343. The slanted cutaway 240 of the housing 200 provides access by an individual to a proximate end of the dispensing gate 305, when the dispensing gate 305 is in the closed position. For example, the individual can use his or her index finger to apply pressure to a dispensing gate 305 extending from the housing 200 near the slanted cutaway 240. Such a design of the housing 200 can influence the individual to move the dispensing device 100 between the open and closed position, while the dispensing device 100 is in an upright position.

A first guide wall 265 is defined at a medial side of the housing 200, while a second guide wall 270 is defined at a lateral side of the housing 200, such that the first guide wall 265 is opposite the second guide wall 270. The first guide wall 265 and second guide wall 270, as portions of the guide system 600, assist in guiding the dispensing gate 305 between the closed position (towards the slanted cutaway 240) and the open position (towards the defined aperture 220). Preferably, the distance between the first guide wall 265 and the second guide wall 270 is substantially equal to the width of the dispensing gate 305, such that the dispensing gate 305 (during use) fits snuggly, but slides smoothly, within the housing 200.

To accommodate a flip-top pouring spout portion 390 of the cover 360 (as described more fully below), the housing 200 can further define a pour spout 235 located on the inner side of the peripheral side wall 215. More particularly, the pour spout 235 can be defined within a portion of the first guide wall 265 near the medial side of the housing 200. The pour spout 235 provides a pouring lip for contents to be easily poured from the container 10, when the flip-top portion 390 of the cover 360 is opened. To accommodate the opening of the flip-top portion 390 of the cover 360 by an individual, the housing 200 can further define a pour spout indent 230 on the outer side of the peripheral side wall 215 located adjacent to the pour spout 235. The pour spout indent 230 is adapted to provide easy access to the flip-top portion 390 of the cover 360 with an individual's finger.

To assist the restraint system 400 in maintaining the dispensing gate 305 between the open and closed positions, the housing 200 can also include a gate locking extension 250, having a first end in communication with the inner side of the peripheral side wall 215 and located at the proximal side of the housing 200 (near the slanted cutaway 240). The gate locking extension 250 extends inwardly and upwardly within the housing 200, such that a second end of the gate locking extension 250 is positioned within the pathway defined for the dispensing gate 305 by the first and second guide walls 265, 270. As configured, the dispensing gate 305 slides over the gate locking extension 250 when the dispensing gate 305 is moved from the closed position to the open position. The gate locking extension 250, however, is adapted to engage a notch 330 located on the bottom 315 of the dispensing gate 305, when the dispensing gate 305 is moved towards the closed position. The gate locking extension 250 prevents the dispensing gate 305 from moving beyond the closed position during use of the dispensing device 100.

The gate locking extension 250 comprises a downwardly extending knob 255 positioned on the underside of the gate locking extension 250, such that the knob 255 does not interfere with the dispensing gate 305 during movement between the open and closed positions. After use, the individual may desire to clean the dispensing device 100. Accordingly, the individual can apply an outwardly and downwardly force to the knob 255 of the gate locking extension 250, thereby disengaging the gate locking extension 250 with the notch 330 of the dispensing gate 305. Knob 255 may have a flat surface on one side for more comfortable pressing by the individual. The dispensing gate 305, therefore, can be temporarily removed from the housing 200, by sliding the dispensing gate 305 past the disengaged gate locking extension 250 towards the proximal side of the housing 200. After cleaning, the dispensing gate 305 can be inserted back within the housing 200 by sliding the dispensing gate 305 towards the distal side of the housing 200, wherein the gate locking extension 250 can re-engage with the notch 330 of the dispensing gate 305.

To provide instructions to the individual on how to disengage the gate locking extension 250, indicia 260 can be placed near the knob 255 of the gate locking extension 250. Generally, the indicia 260 is located on a ridge within the housing 200 and can be read by the individual from the lower open end 210 of the housing 200, after the housing 200 has been removed from the container 10. One skilled in the art will recognize that the indicia 260 can include a variety of appropriate instructions for the individual. For example, and not limitation, the indicia 260 can include the instructions “Pull Back Knob to Clean” or “Pull Back Knob to Remove.”

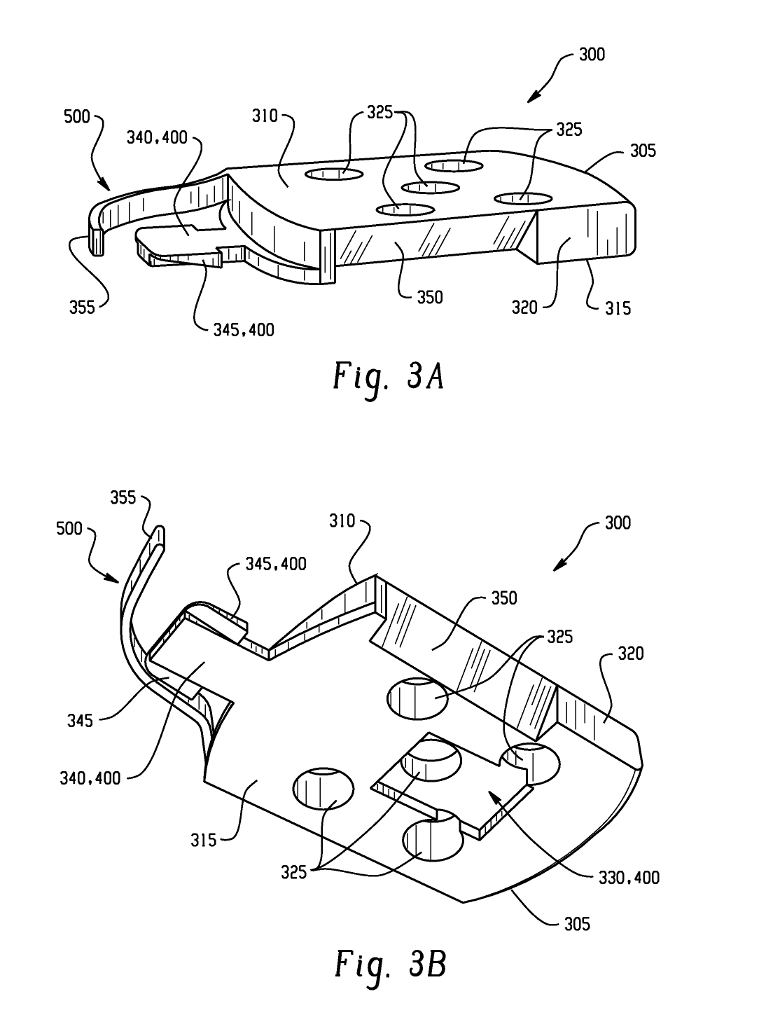

As illustrated in FIGS. 3A-3B, the dispensing gate 305 comprises a top 310, bottom 315, and peripheral side wall 320 extending from the top 310 to the bottom 315. The dispensing gate 305 is formed to define at least one aperture 325 creating a channel from the top 310 to the bottom 315 of the dispensing gate 305. The at least one aperture 325 is adapted to permit the contents of the container 10 to pass from the inside of the container 10 to the outside of the container 10, when the dispensing gate 305 is in the open position. One skilled in the art will recognize that the at least one aperture 325 can include multiple shapes, sizes, and arrangements.

The dispensing gate 305 further defines a notch 330 within the bottom 315 of the dispensing gate 305, such that the notch 330 is adapted to temporarily engage the gate locking extension 250 of the housing 200, when the dispensing gate 305 is in the closed position. The notch 330 (or detent) forms a cavity for receiving the gate locking extension 250, but does not pass completely through to the top 310 of the dispensing gate 305. The gate locking extension 250 does not necessarily touch the upper surface of notch 330.

To accommodate the flip-top pouring lid 390 of the cover 360, the dispensing gate 305 can define a pour spout cutout 350 on the peripheral side wall 320, such that the pour spout cutout 350 is positioned on the medial side of the dispensing gate 305. When the dispensing gate 305 is within the housing 200 (e.g., in the closed position), the pour spout cutout 350 of the dispensing gate 305 is positioned substantially parallel to the pour spout 235 defined at the medial side of the housing 200. Accordingly, the pour spout cutout 350 of the dispensing gate 305 and the pour spout 235 of the housing 200 cumulatively define a pouring channel in which the contents of the container 10 can be poured from the container 10, when the flip-top pouring lid 390 is open.

The dispensing gate 305 further comprises a bias 355 extending outwardly from a distal end in a direction substantially perpendicular from the at least one aperture 325. The bias 355 is adapted to move the dispensing gate 305 from the open position to the closed position, when triggered. Typically, the bias 355 is in a compressed, energized state when the dispensing gate 305 is in the open position. Therefore, the bias 355 is constantly attempting to move the dispensing gate 305 back to the closed position. The bias 355 is in an uncompressed, non-energized state when the dispensing gate 305 is in the closed position. Generally, as the dispensing gate 305 is moved towards the open position, the bias 355 engages the inner side of the housing 200 near the distal side. The bias 355 attempts to push the dispensing gate 305 away from the distal side of the housing 200, while the dispensing gate 305 is in the open position.

One skilled in the art will recognize that the bias 355 can include, but is not limited to, a spring, a coil, a pressurized chamber, a flexible piece of metal, rubber, or plastic, or other appropriate device that is compressible, yet resilient. Preferably, the bias 355 is a flexible piece of plastic, with enough resilience to effectively move the dispensing gate 305 from the open position to the closed position (even if portions of the contents of the container 10 interfere with the movement with the dispensing gate 305), yet flexible enough to allow for relatively easy movement of the dispensing gate 305 by an individual.

In a first embodiment of the present invention, the dispensing gate 305 also comprises a trigger or release extension 340. The trigger or release extension 340 extends outwardly from the distal end of the dispensing gate 305, in a direction generally perpendicular to the at least one aperture 325. The trigger or release extension 340 is adapted to temporarily engage the housing aperture 220, whereby the trigger or release extension 340 maintains the dispensing gate 305 in the open position. The trigger or release extension 340 can include a plurality of outwardly extending wings 345, thereby forming a generally T-shape. The end of the trigger or release extension 340 and the plurality of outwardly extending wings 345 can be tapered, such that when the trigger or release extension 340 engages the housing aperture 220, the trigger or release extension 340 is moved slightly upwardly as it passes through the housing aperture 220. Likewise, the housing aperture 220 can be slightly tapered to properly engage the trigger or release extension 340 and the plurality of outwardly extending wings 345.

The housing aperture 220 can include a lower portion 225 having a width slightly less than the upper portion of the aperture 220, thereby forming a generally T-shape. Preferably, the upper portion of the aperture 220 is wide enough to allow the trigger or release extension 340 and the plurality of outwardly extending wings 345 to adequately pass through the housing 200. The lower portion 225 of the aperture 220 is only as wide as the narrow portion of the trigger or release extension 340 (the portion without the outwardly extending wings 345). Accordingly, as the trigger or release extension 340 and the outwardly extending wings 345 engage the aperture 220, the trigger or release extension 340 is guided slightly upwardly towards the upper portion of the aperture 220.

Once the trigger or release extension 340 and the outwardly extending wings 345 pass through the upper portion of the aperture 220, the narrower portion of the trigger or release extension 340 falls into the lower portion 225 of the aperture 220. The outwardly extending wings 345 are, therefore, outside the housing 200, but adjacent to the outer side of the peripheral side wall 215 of the housing 200. As the outwardly extending wings 345 cannot pass through the lower portion 225 of the housing aperture 220, the dispensing gate 305 is temporarily maintained in the open position. After use of the dispensing device 100, the individual can apply an upward force to the trigger or release extension 340, thereby raising the outwardly extending wings 345 towards the upper portion of the housing aperture 220. The outwardly extending wings 345 of the trigger or release extension 340 can then pass through the upper portion of the housing aperture 220 (and into the housing 200) as the bias 355 moves the dispensing gate 305 towards the closed position.

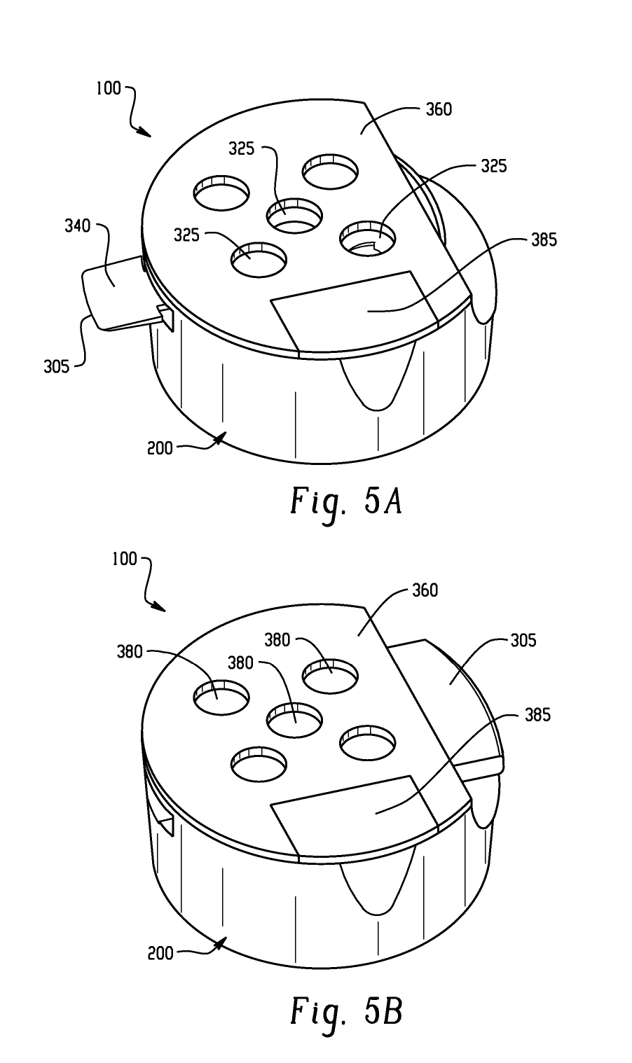

In a second embodiment of the present invention, the dispensing gate 305 is formed to define a catch aperture 335 near the distal side. As the dispensing gate 305 is moved to the open position, the catch aperture 335 engages a catch 280 formed within the housing 200. The catch 280 temporarily maintains the dispensing gate 305 in the open position. As described more fully below with reference to FIGS. 5A-5G, a triggering or release button 343 is used to disengage the catch 280 from the catch aperture 335, thereby allowing the bias 355 of the closing system 500 to move the dispensing gate 305 from the open position to the closed position.

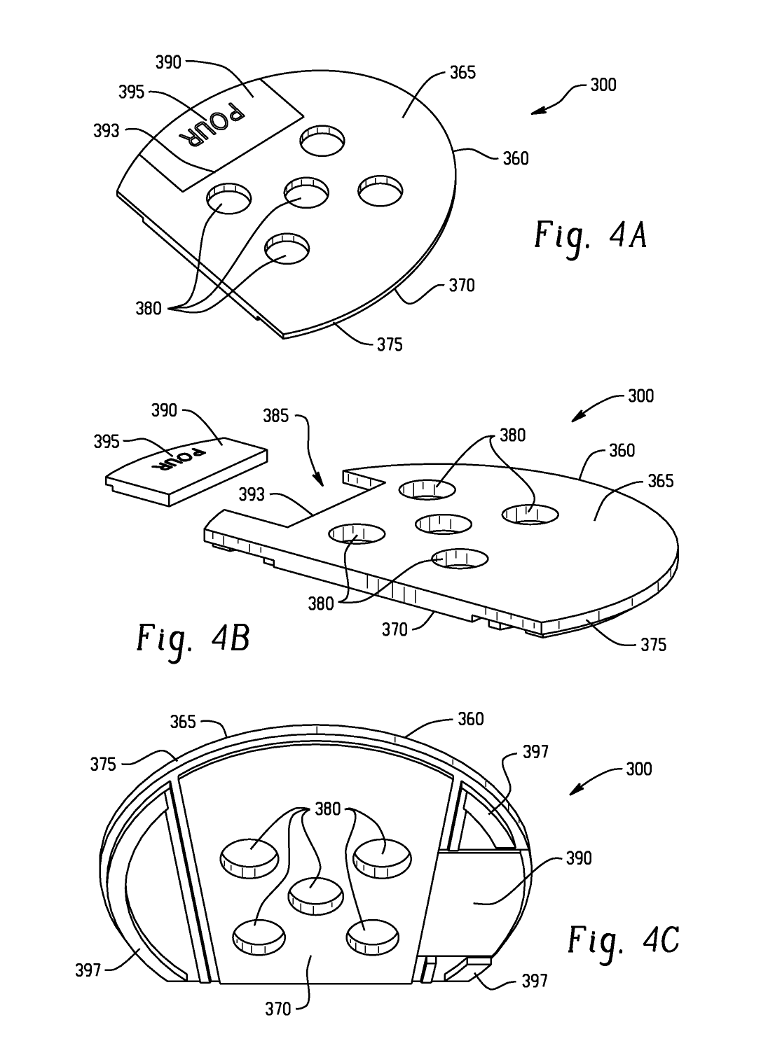

As illustrated in FIGS. 4A-4C, the cover 360 comprises a top 365, a bottom 370, and a peripheral side wall 375 extending from the top 365 to the bottom 370 of the cover 360. The cover 360 is formed to define at least one aperture 380 extending from the top 365 to the bottom 370. Preferably, the at least one aperture 380 is shaped and arranged substantially similar to the at least one aperture 325 of the dispensing gate 305. The dispensing system 300 includes the interplay between the cover 360 and the dispensing gate 305, such that when the at least one aperture 380 of the cover 360 is aligned with the at least one aperture 325 of the dispensing gate 305, the dispensing device 100 is in the open position. When the at least one aperture 380 of the cover 360 is not aligned with the at least one aperture 325 of the dispensing gate 305, the dispensing device 100 is in the closed position.

The cover 360 is further formed to define a cutout 385 for a pouring channel defined by the pour spout 235 of the housing 200 and the pour spout cutout 350 of the dispensing gate 305. The cutout 385 is defined at the medial side of the cover 360, such that when the cover 360 engages the housing 200, the cutout 385 is aligned with the pour spout 235 of the housing 200. The cover 360 includes a pour lid 390 having the substantially same shape as the cutout 385. The pour lid 390 can be inserted into the cutout 385 of the cover 360, whereby the pour lid 390 can be moved between an open position and a closed position. In the open position, contents within the container 10 can be poured from the container 10 via the pour spout 235. In the closed position, however, the contents cannot be poured from the pour spout 235. The pour lid 390 forms a living hinge 393 with the cover 360, thus allowing the pour lid 390 to be pivotally connected to the cover 360. The pour lid 390 can then pivot between the open and closed position. One skilled in the art will recognize that the pour lid 390 can be hingingly connected to cover 360 in a variety of other configurations, within the scope of the present invention.

The pour lid 390 can include indicia 395 indicating to an individual that the pour lid 390 can be pivoted between the closed and open positions. One skilled in the art will recognize that the indicia 395 on the pour lid 390 can include a variety of suitable markings to instruct the individual that the pour lid 390 can be utilized. For example, and not limitation, the indicia 395 on the pour lid 390 can include the word “Pour” or “Lift.” Alternatively and/or additionally, a symbol indicating the use of the pour lid 390 can be used.

The cover 360 further comprises a plurality of engagement extensions 397 extending downwardly from the bottom 370 of the cover 360. The plurality of engagement extensions 397 are adapted to engage the upper open end 205 of the housing 200, thereby allowing the cover 360 to close the upper open end 205 of the housing 200. Cover 360 and housing 200 can utilize other forms of engagement extensions 397 to connect to one another, including, but not limited to, male and female connectors. The cover 360 can, therefore, assist in maintaining the dispensing gate 305 within the housing 200 during use. Further, the cover 360 can comprise a downward protrusion (not shown) which, when the cover 360 is engaged with the housing 200, assists in maintaining the release extension 340 or button 343 (described below) in horizontal alignment within the housing 200.

The cover 360 is attached to the upper open end 205 of the housing 200, thereby encapsulating the inner cavity within the housing 200. The dispensing gate 305 having a trigger or release extension 340 is inserted into the proximate side of the housing 200, whereby the distal end of the dispensing gate 305 (the end with the bias 355 and trigger or release extension 340) is inserted into the groove defined by the first and second guide walls 265, 270 of the housing 200.

The dispensing device 100, as illustrated in FIGS. 5A-5B, includes an open position and a closed position. As the dispensing gate 305 is received within the housing 200, the first and second guide walls 265, 270 maintain the dispensing gate 305 in a direction towards the open position (e.g., towards the distal side of the housing 200). The dispensing gate 305 slides over the gate locking extension 250 of the housing 200, thereby causing the gate locking extension 250 to be pushed downward. Once the dispensing gate 305 is received a predetermined distance within the housing 200, the gate locking extension 250 engages the notch 330 of the dispensing gate 305, as the distal end of the gate locking extension 250 moves upwardly into the notch 330. During use of the first embodiment of the present invention, the housing 200 is attached to the container 10 having contents for dispensing.

To activate the present invention, the individual can push the dispensing gate 305 towards the open position, whereby the bias 355 engages the inner side of the peripheral side wall 215 of the housing 200, such that the bias 355 begins to be compressed. The trigger or release extension 340 moves toward the housing aperture 220, where the tapered edges of the housing 200 and the outwardly extending wings 345 of the trigger or release extension 340 meet causing the trigger or release extension 340 to move slightly upward towards the upper portion of the housing aperture 220. Once the plurality of outwardly extending wings 345 passes through the upper portion of the housing aperture 220, the narrow portion of the trigger or release extension 340 falls into the lower portion 225 of the aperture 220.

Once the individual stops sliding the dispensing gate 305 into the housing 200, the compressed and energized bias 355 attempts to move the dispensing gate 305 from the open position back towards the closed position (e.g., the proximate side of the housing 200). The plurality of outwardly extending wings 345, however, are engaged with the outer side of the peripheral side wall 215 of the housing 200 and, therefore, maintains the dispensing gate 305 in the open position. The individual can then dispense the contents from the container 10, as the at least one aperture 325 of the dispensing gate 305 are aligned with the at least one aperture 380 of the cover 360.

By applying an upward force to the trigger or release extension 340, the outwardly extending wings 345 are moved upwardly towards the upper portion of the housing aperture 220, which is wide enough for the outwardly extending wings 345 to pass through. The compressed and energized bias 355 moves the dispensing gate 305 towards the proximate side of the housing 200. As the dispensing gate 305 moves toward the closed position, the gate locking extension 250 engages the notch 330 of the dispensing gate 305, thereby preventing the dispensing gate 305 from moving beyond the closed position. The individual now cannot dispense the contents of the container 10, as the at least one aperture 325 of the dispensing gate 305 is not aligned with the at least one aperture 380 of the cover 360.

One skilled in the art will recognize that the trigger or release extension 340, the outwardly extending wings 345, and the housing aperture 220 can be configured in different arrangements, so that the trigger or release extension 340 can be engaged by applying an upward, downward, or lateral force, without departing from the scope of the present invention.

The individual can flip open the pour lid 390 of the cover 360 and pour the contents from the container 10 via the pour spout 235. When complete, the individual can push the pour lid 390 down (as it pivots along the cover 360) until it snaps shut with the cover 360. When the pour lid 390 is closed, none of the contents of the container 10 can be poured from the pour spout 235.

To remove the dispensing gate 305 from the housing 200, the individual disengages the housing 200 from the container 10 and presses outwardly and downwardly upon the knob 255 of the gate locking extension 250. As the gate locking extension 250 is lowered, it disengages with the notch 330 of the dispensing gate 305, such that the dispensing gate 305 can be completely removed from the housing 200 for cleaning or replacement, if necessary.

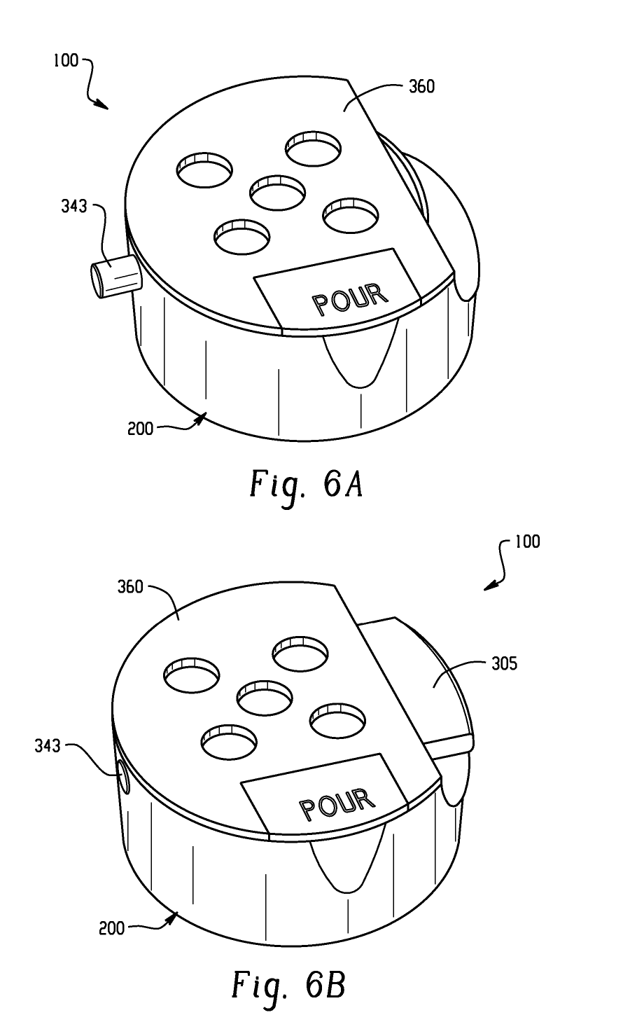

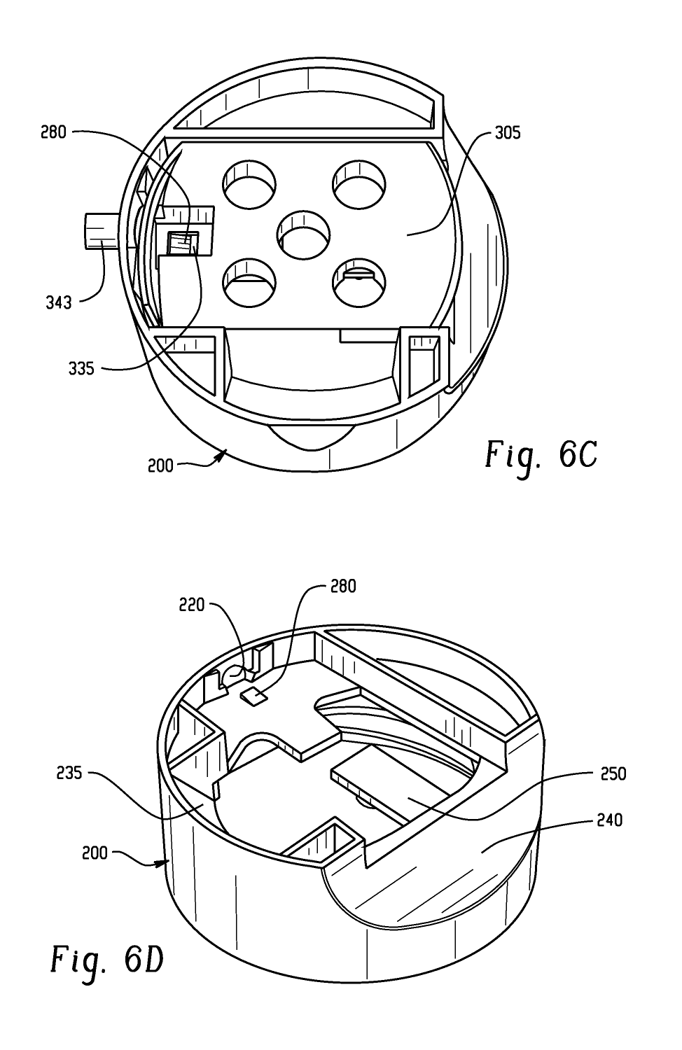

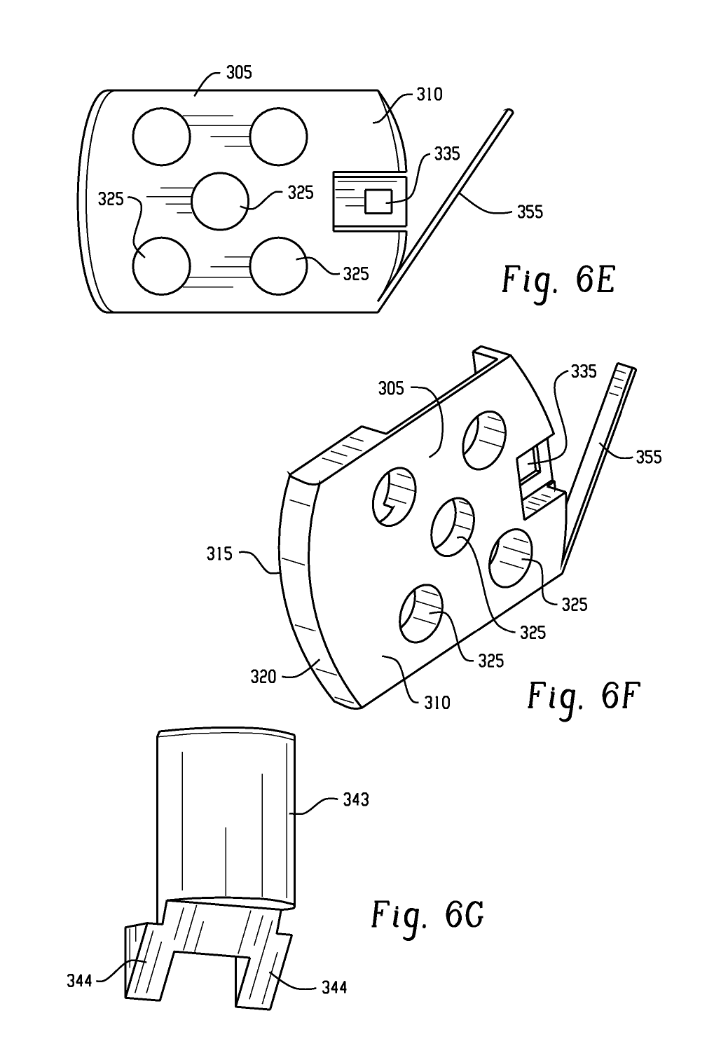

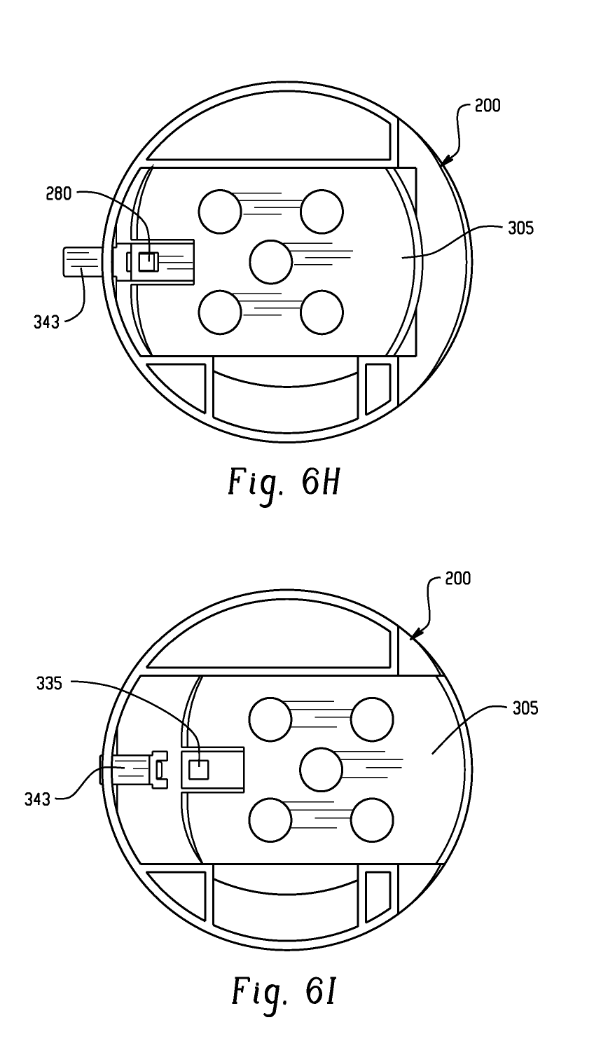

As described above, FIGS. 6A-6I illustrate a second embodiment of the present invention, wherein the dispensing gate 305 does not include a trigger or release extension 340. Instead, the dispensing gate 305 is formed to define a catch aperture 335 near the distal end of the dispensing gate 305. The housing 200 is formed to include a catch 280 near the distal side of the housing 200 (near the housing aperture 220). As the dispensing gate 305 is moved towards the open position, the catch 280 of the housing 200 engages the catch aperture 335 of the dispensing gate 305, which maintains the dispensing gate 305 in the open position against the attempt of the bias 355 to move the dispensing gate 305 back to the closed position.

The dispensing device 100 further comprises a button 343 adapted to be received within the housing aperture 220. The button 343 includes a proximate end having a plurality of tapered extensions 344. The plurality of tapered extensions 344 generally engages the inner side of the peripheral side wall 215 of the housing 200 near the housing aperture 220. As such, only the distal end of the button 343 can be received by the housing aperture 220, while the plurality of tapered extensions 344 remains within the housing 200 (preventing the button 343 from being removed from the housing 200). While in the open position, the bias 355 presses against the proximate end of the release button 343 and, therefore, maintains the plurality tapered extensions 344 adjacent the inner side of the housing 200. Generally, the diameter of the release button 343 is substantially equal to the diameter of the housing aperture 220, such that an adequate amount of resistance (or friction) is caused when the release button 343 is pushed inward. The release button 343 then remains within the housing 200 until an individual moves the dispensing gate 305 back to the open position, whereby the release button 343 is forced to extend from the housing 200 through the housing aperture 220 via the bias 355.

When the dispensing gate 305 is in the open position, the individual can apply an inward triggering force to the button 343. The button 343 moves a predetermined distance inwardly (against the bias 355), until the plurality of tapered extensions 344 engages the dispensing gate 305 near the catch aperture 335. The plurality of tapered extensions 344 causes the dispensing gate 305 to move slightly upward, such that the catch aperture 335 disengages with the catch 280 of the housing 200. The bias 355 then moves the dispensing gate 305 towards the closed position. The gate locking extension 250 then engages the notch 330 of the dispensing gate 305 and maintains the dispensing gate 305 in the closed position.

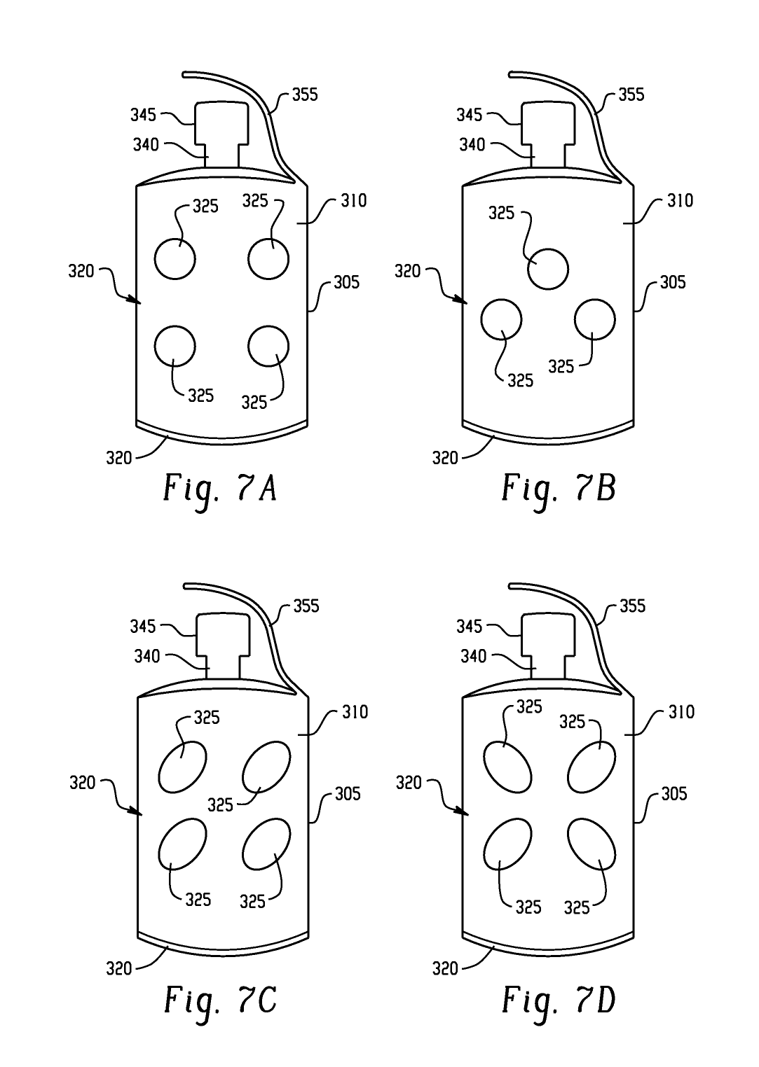

FIGS. 7A-7D illustrate a dispensing gate 305 defining multiple apertures 325 having different shapes, sizes, and arrangements. Each differently arranged dispensing gate 305 provides a unique dispensing rate of the contents of the container 10 and can facilitate in the dispensing of different types of contents having varying size and shape. One skilled in the art will recognize that the dispensing gate 305 of the present invention can include a different number of apertures 325 having various shapes, sizes, and arrangements, without departing the scope of the present invention. Accordingly, the present invention is not limited to the number, arrangement, and shape of the apertures 325 provided in FIGS. 7A-7D. Preferably, the number, arrangement, and shape of apertures 325 for the dispensing gate 305, substantially correspond to the number, arrangement, and shape of apertures 380 of the cover 360.

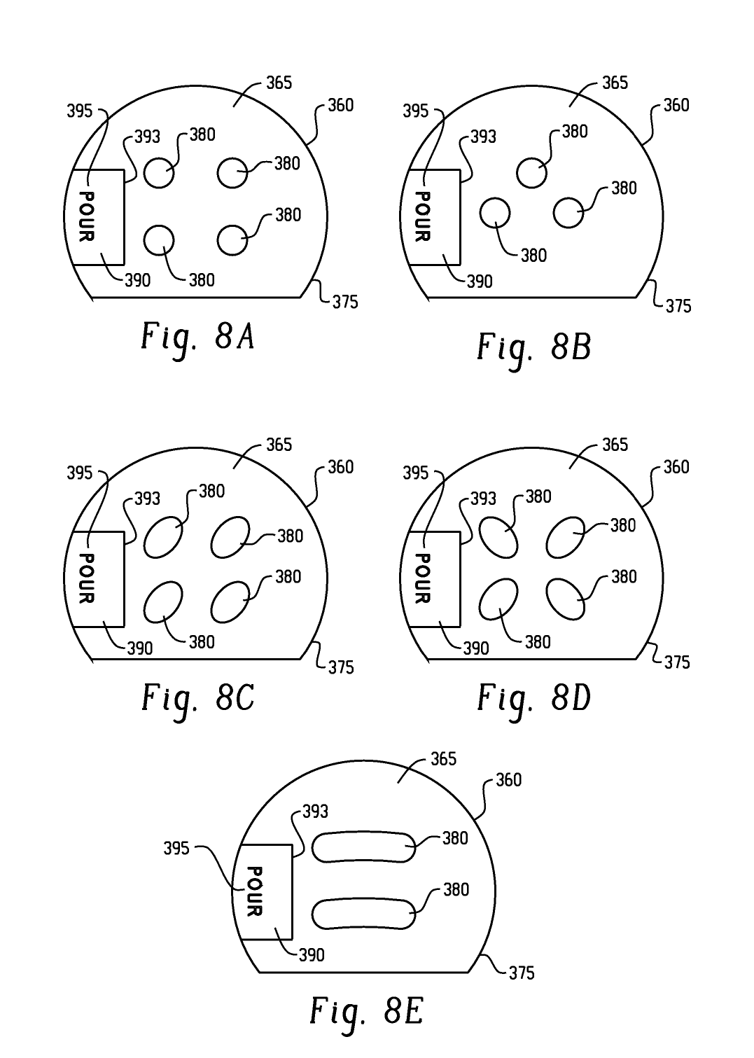

FIGS. 8A-8E illustrate a cover 360 defining multiple apertures 380 having different shapes, sizes, and arrangements. Each differently arranged cover 360 provides a unique dispensing rate of the contents of the container 10 and can facilitate in the dispensing of different types of contents having varying size and shape. One skilled in the art will recognize that the cover 360 of the present invention can include a different number of apertures 380 having various shapes, sizes, and arrangements, without departing the scope of the present invention. Accordingly, the present invention is not limited to the number, arrangement, and shape of the apertures 380 provided in FIGS. 8A-8E. Preferably, the number, arrangement, and shape of apertures 380 for the cover 360, substantially correspond to the number, arrangement, and shape of apertures 325 of the dispensing gate 305.

One skilled in the art will recognize that the housing 200, dispensing gate 305, cover 360, restraint system 400, closing system 500, guide system 600, and all of the components and/or element thereof can be made of a variety of suitable materials including, but not limited to, plastic, rubber, metal, ceramic, or other suitable materials or a combination thereof.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A dispensing device for dispensing the contents of a container comprising:
a dispensing gate having an open position and a closed position;
a closing system for moving the dispensing gate from the opened position to the closed position; and
a restraint system to limit the movement of the dispensing gate only between the open position and the closed position.

2. The dispensing device of claim 1, wherein the closing system comprises a cover including a plurality of outer apertures and wherein the dispensing gate comprises a plurality of inner apertures that substantially match the outer apertures of the cover.

3. The dispensing device of claim 2, wherein, in the open position, the plurality of inner apertures of the dispensing gate are aligned with the plurality of outer apertures of the cover, thereby allowing contents to be dispensed from the container.

4. The dispensing device of claim 1, wherein the closing system comprises a bias that influences the dispensing gate to the closed position and a release mechanism adapted to activate the bias, when the cap is in the open position.

5. The dispensing device of claim 4, wherein a triggering mechanism activates the bias to move the dispensing gate from the open position to the closed position.

6. The dispensing device of claim 1, further comprising a guide system adapted to provide guided travel of the dispensing gate, thereby ensuring that the restraint system is properly aligned to adequately maintain the dispensing gate in the open and closed positions.

7. A dispensing device for dispensing contents of a container comprising:
a housing adapted to engage the container;
a dispensing gate receivable within the housing, the dispensing gate having an open and a closed position;
a spring in communication with the dispensing gate;
a cover adapted to engage the top of the housing to partially encapsulate the dispensing gate within the housing;
a restraint extension adapted to maintain the dispensing gate in the closed position; and
a triggering button adapted to engage the spring to move the dispensing gate from the open position to the closed position.

8. The dispensing device of claim 7, wherein the cover and the dispensing gate each comprise one or more corresponding apertures for dispensing contents of the container, such that contents within the container can be dispensed when the apertures of the cover are aligned with the apertures of the dispensing gate.

9. The dispensing device of claim 7, further comprising a groove defined by guide walls within the housing, wherein the groove provides a pathway for the dispensing gate to move between the open and closed positions.

10. The dispensing device of claim 7, wherein the housing of the dispensing device comprises a catch adapted to temporarily engage and maintain the dispensing gate in the open position.

11. The dispensing device of claim 10, wherein the catch maintains the dispensing gate in the open position, until the triggering button is engaged, thereby activating the spring to move the dispensing gate from the open position to the closed position where the restraint extension engages the dispensing gate.

12. A method for operating a dispensing device comprising:
pushing a proximate end of a dispensing gate inwardly towards a housing, causing the dispensing gate to slide forward;
disengaging a restraint extension of the housing from the dispensing gate;
engaging the dispensing gate with a catch of the housing, causing the dispensing gate to maintain a position where one or more apertures of the dispensing gate is aligned with one or more apertures of a cover, thereby allowing contents of the container to be dispensed.

13. The method of claim 12, wherein a spring is used to bias the dispensing gate towards a closed position when the dispensing gate is not engaged with the catch of the housing.

14. The method of claim 13, further comprising engaging a triggering button causing the catch to disengage with the dispensing gate, thereby allowing the spring to move the dispensing gate to the closed position, where the restraint extension engages the dispensing gate and maintains the dispensing gate in the closed position.
